(19) United States
(12) Patent Application Publication
(10) Pub. No.: US 2007/0251018 A1
(43) Pub. Date: Nov. 1, 2007

(54) Apparatus and method for an electric jack

(76) Inventor: Farhad Razzaghi, Douglasville, GA (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/824,163

(22) Filed: Jun. 28, 2007

Related U.S. Application Data
(62) Division of application No. 11/051,730, filed on Feb. 4, 2005.

(51) Int. Cl. B25F 1/02

(52) U.S. Cl. 7/100

(57) ABSTRACT

An apparatus and method for an electric jack, wherein an electrically powered jack is provided for at least partially raising and lowering an automobile off a ground surface. The apparatus may be utilized in conjunction with a conventional portable car jack, wherein the apparatus comprises a power drill, a rod, and a plurality of jack adapters. Each jack adapter is specifically designed to attach to a particular type of car jack, thus providing an apparatus that may be utilized with an assortment of car jacks.

### RELATED APPLICATION

The present non-provisional utility application is a divisional of, and hereby claims priority to, and the full benefit of, U.S. patent application entitled, “Apparatus and Method for an Electric Jack”, having assigned Ser. No. 11/051,730, filed on Feb. 4, 2005 on behalf of Farhad Razzaghi, incorporated herein by reference.

### TECHNICAL FIELD

The present invention relates generally to automobile repair equipment, and more specifically to an apparatus and method for an electric jack for at least partially lifting or raising a vehicle off a ground surface and, thereby, facilitate repair and/or maintenance of same.

### BACKGROUND OF THE INVENTION

In the repair and maintenance of automobiles, it is often necessary to raise an automobile to change a tire or access the underside of the automobile. Accordingly, a variety of car jacks have been developed for lifting an automobile from a ground surface. Available car jacks, however, are typically manually operated and therefore require substantial laborious physical effort on the part of the user. Such jacks present difficulties for the elderly and handicapped and are especially disadvantageous under adverse weather conditions. In light of such inherent disadvantages, commercial automobile repair and service stations are commonly equipped with large car lifts, wherein such lifts are raised and lowered via electrically-powered systems. However, due to their shear size and high costs of purchasing and maintaining electrically-powered car lifts, such lifts are not available to the average car-owner.

To resolve the foregoing issues and concerns, portable car jacks have been designed to operate on electricity, wherein such jacks draw power from the automobile battery. For example, U.S. Pat. No. 6,685,169 to Shim (“Shim '169”) discloses a motor-operated jack for raising or lifting vehicles to desired heights and, more particularly, to a motor-operated jack consisting of a power transmission unit and a lifting unit. In another example, U.S. Pat. No. 4,093,181 to Ivins (“Ivins '181”) teaches an automotive jack having a motorized carriage on which is carried a rotatable member engageable with a series of recesses located along a jack standard. The carriage is roller mounted on the jack standard and includes a bumper engaging arm. A reversible motor drives the rotatable member through a gear reduction, worm drive which restricts carriage movement to only motor powered movement.

Such electrically-powered portable jacks not only remove the arduous task of lifting an automobile via manually-operated jacks, but further decrease the time needed to repair the automobile. Such a feature can be especially advantageous when it is necessary to repair an automobile on the side of a roadway or under other hazardous conditions.

However, despite their advantages, the above-referenced devices nevertheless suffer from several inherent structural and functional limitations. In general, conventional electric jacks are only suitable for use with automobiles that are designed by a particular car manufacturer. This problem is exacerbated given the large number of automobiles that are imported from foreign countries. As such, a jack that is adapted for use with a CHEVROLET truck may not function properly to lift a MERCEDES BENZ sedan, and vice versa. Such a disadvantage is especially burdensome to the large number of people who own more that one car and/or who prefer to switch automobiles on a frequent basis.

Furthermore, available electric jacks are typically large and heavy; and, as such, are cumbersome to store, transport, carry and/or move into the proper position under an automobile for safely and effectively raising the automobile. In addition to the difficulties in assembling and setting up electric jacks, such jacks are generally not adapted to be readily disassembled and stored after the automobile repairs have been completed.

Therefore, it is readily apparent that there is a need for an apparatus and method for an electric jack that eliminates the arduous tasks associated with the use and application of conventional manually-operated jacks. There is a further need for such an electric jack that is light-weight and may be readily set up, utilized, disassembled, and subsequently stored. There is still a further need for such an apparatus and method that is adapted for use with a plurality of automobiles, thereby removing the need for the purchase, maintenance and storage of multiple car jacks.

### BRIEF SUMMARY OF THE INVENTION

Briefly described, in a preferred embodiment, the present invention overcomes the above-mentioned disadvantages and meets the recognized need for such a device by providing an apparatus and method for an electric jack, wherein an electrically driven jack is provided for coupling to an assortment of car jack makes and models for expeditiously raising and lowering a variety of automobiles.

According to its major aspects and broadly stated, the present invention in its preferred form is a tool assembly for use with a conventional portable car jack, wherein the tool assembly comprises a power drill, a drive rod, and a plurality of jack adapters.

More specifically, the tool assembly may be utilized in conjunction with a scissor jack, wherein the scissor jack comprises a threadable jack shaft and a vehicle support member, and wherein the vehicle support member is raised when a torsional force is applied to the threadable jack shaft.

The tool assembly comprises a plurality of jack adapters for providing a torsional force to the car jack, wherein each jack adapter comprises a shaft and a coupler. The shaft is coupled to a drive rod, which is subsequently coupled to a power drill. The coupler of the selected jack adapter is removably connected to the threadable jack shaft of the car jack. Accordingly, activation of the power drill provides an electrically-driven, torsional force that is transferred from the tool and into the threadable jack shaft of the car jack, which consequently raises the vehicle support member of the car jack.

As such, a feature and advantage of the present invention is its use of electricity to power a car jack, thereby eliminating the arduous tasks associated with manually operated car jacks.

Another feature and advantage of the present invention is its ability to quickly and effectively raise and lower a vehicle, thereby providing a device that is energy and time efficient.

Still another feature and advantage of the present invention is its ability to raise and lower a vehicle in a safe manner.

Yet another feature and advantage of the present invention is its ability to function as a universal car jack, wherein the device may be utilized to raise and lower a variety of automobiles.

Still yet another feature and advantage of the present invention is its lightweight and compact design, which provides an apparatus that is easy to set-up, utilize, disassemble and store.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternative Embodiments with reference to the accompanying drawing figures, in which like reference numerals denote similar structure and refer to like elements throughout, and in which:

FIG. 1 is a perspective view of an apparatus for an electric jack according to a preferred embodiment of the present invention;

FIG. 2A is a perspective view of a jack adapter of an apparatus for an electric jack according to a preferred embodiment of the present invention;

FIG. 2B is a perspective view of an apparatus for an electric jack according to a preferred embodiment of the present invention;

FIG. 3A is a perspective view of a jack adapter of an apparatus for an electric jack according to an alternative embodiment of the present invention;

FIG. 3B is a perspective view of an apparatus for an electric jack according to an alternative embodiment of the present invention;

FIG. 4A is a perspective view of a jack adapter of an apparatus for an electric jack according to an alternative embodiment of the present invention;

FIG. 4B is a perspective view of an apparatus for an electric jack according to an alternative embodiment of the present invention;

FIG. 5A is a perspective view of a jack adapter of an apparatus for an electric jack according to an alternative embodiment of the present invention;

FIG. 5B is a perspective view of an apparatus for an electric jack according to an alternative embodiment of the present invention;

FIG. 6A is a perspective view of a jack adapter of an apparatus for an electric jack according to an alternative embodiment of the present invention;

FIG. 6B is a perspective view of an apparatus for an electric jack according to an alternative embodiment of the present invention;

FIG. 7A is a perspective view of a jack adapter of an apparatus for an electric jack according to an alternative embodiment of the present invention;

FIG. 7B is a perspective view of an apparatus for an electric jack according to an alternative embodiment of the present invention;

FIG. 8A is a perspective view of a jack adapter of an apparatus for an electric jack according to an alternative embodiment of the present invention;

FIG. 8B is a perspective view of an apparatus for an electric jack according to an alternative embodiment of the present invention;

FIG. 9A is a perspective view of an apparatus for an electric jack according to an alternative embodiment of the present invention; and

FIG. 9B is a perspective view of an apparatus for an electric jack according to an alternative embodiment of the present invention.

### DETAILED DESCRIPTION OF THE PREFERRED AND SELECTED ALTERNATIVE EMBODIMENTS

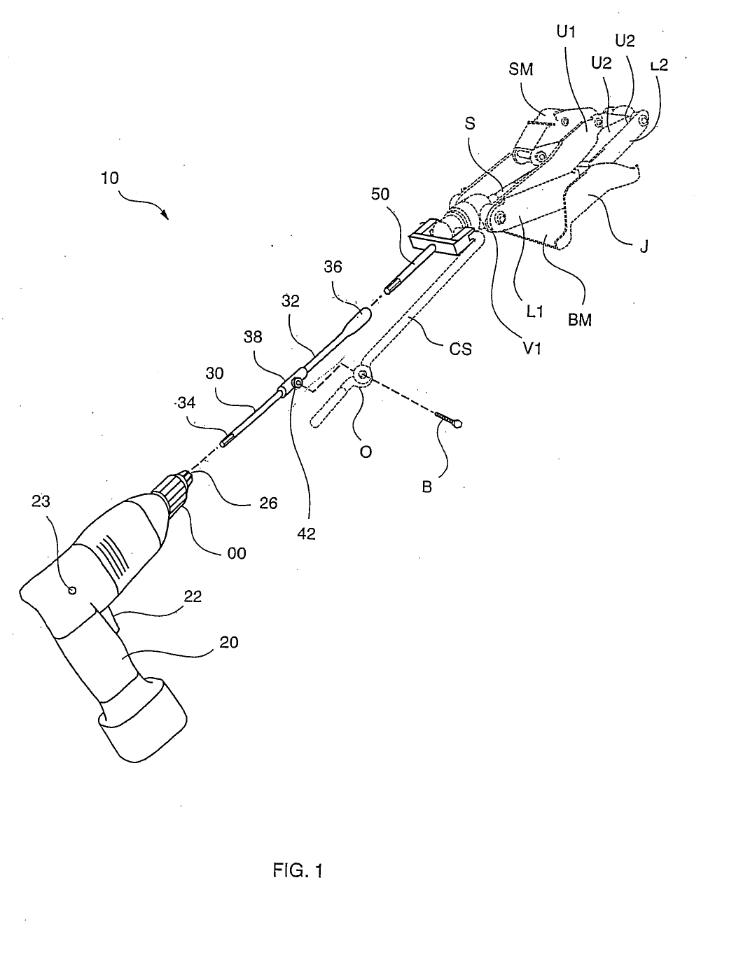

In describing the preferred and selected alternative embodiments of the present invention, as illustrated in FIGS. 1-9B, specific terminology is employed for the sake of clarity. The invention, however, is not intended to be limited to the specific terminology so selected, and it is to be understood that each specific element includes all technical equivalents that operate in a similar manner to accomplish similar functions.

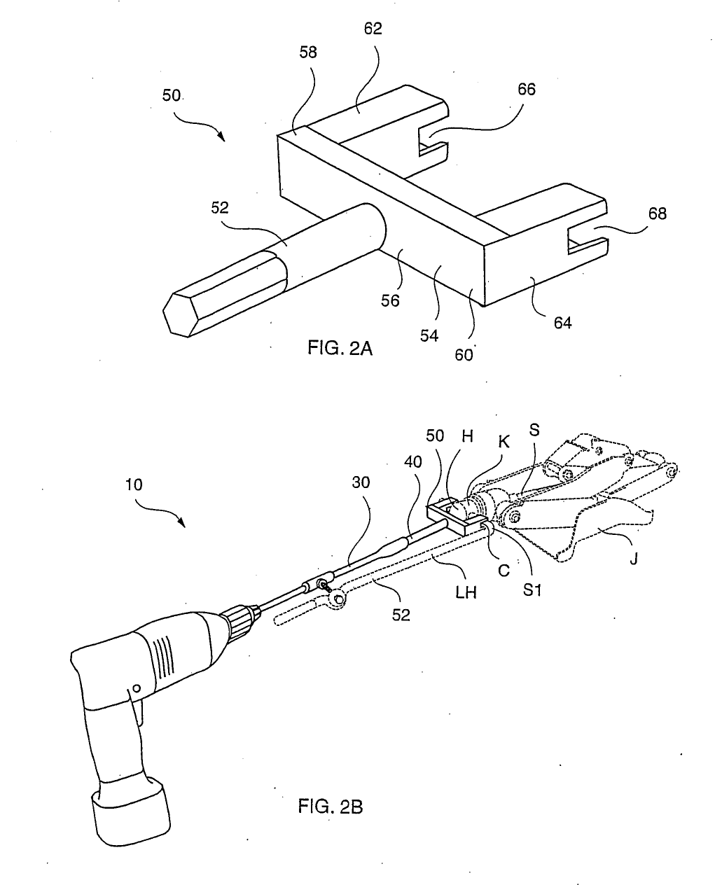

Referring now to FIGS. 1-2B, the present invention in a preferred embodiment is tool assembly 10, wherein tool assembly 10 preferably generally comprises power drill 20, drive rod 30, and a plurality of jack adapters 50. Preferably, tool assembly 10 may be utilized in conjunction with car jack J, wherein car jack J is a conventional portable car jack or other apparatus for raising and lowering automobiles. Preferably, and for purposes of illustrating an exemplary application of tool assembly 10, car jack J is a scissor jack, wherein car jack J generally comprises base member BM, lower arms L1, L2, upper arms U1, U2, threadable jack shaft S and vehicle support member SM. It should be recognized that other car jacks actuated via a rotational and torsional force may be also utilized.

Briefly described, lower arms L1, L2 each preferably comprise a first end and a second end, wherein the first ends of lower arms L1, L2 are preferably pivotally connected to base member BM. Upper arms U1, U2 each preferably comprise a first end and a second end, wherein the first ends of upper arms U1, U2 are preferably pivotally connected to the second ends of lower arms L1, L2, respectively, preferably at vertices V1, V2, respectively. The second ends of upper arms U1, U2 are preferably pivotally connected to vehicle support member SM.

Further, jack shaft S is preferably threadably engaged within vertices V1, V2 of car jack J, wherein jack shaft S is preferably linked to knob K. Knob K is preferably adapted to receive a rotational and torsional force, wherein such rotational and torsional forces are preferably transmitted to jack shaft S via knob K. Due to the various types and styles of car jacks, a variety of knobs, actuators, handles, and the like, have been developed to optimize the transfer of force from a power source to a selected car jack. Although more fully described below with reference to application of tool assembly 10, examples of the variety of knobs that are commonly available and utilized on car jacks are shown in FIGS. 1-9B.

When a clockwise rotational and/or torsional force is applied to knob K, jack shaft S is preferably rotated within vertices V1, V2, wherein vertices V1, V2 are preferably subsequently urged towards one another, thereby preferably forcing vehicle support member SM away from base member BM. When a counterclockwise torsional force is applied to knob K, jack shaft S is preferably rotated within vertices V1, V2, wherein vertices V1, V2 are preferably subsequently forced away from another, thereby preferably urging vehicle support member SM toward base member BM. Accordingly, when base member BM is positioned on a ground surface, rotation of jack shaft S in a clockwise direction preferably raises vehicle support member SM, wherein rotation of jack shaft S in a counterclockwise direction preferably lowers vehicle support member SM.

Drill 20 is preferably a conventional power drill comprising a mechanical drive means to create a rotational force, wherein such a mechanical drive means is preferably electrically-powered via a battery source and/or via a cigarette lighter. Drill 20 further preferably comprises trigger 22 for activating the mechanical drive means, selector 23 for toggling between a clockwise rotational direction and a counterclockwise rotational direction, and chuck 24 for holding a drill bit or rod 30 therewithin. Preferably, chuck 24 comprises aperture 26, wherein aperture 26 is hexagon-shaped, and wherein aperture 26 is adapted to receive and retain a drill bit or rod 30 therewithin, as more fully described below. It is contemplated that chuck 24 could further comprise a mechanical tightening mechanism to removable secure a drill bit or rod 30 to drill 20, as is commonly known within the art.

Rod 30 is preferably substantially cylinder-shaped, wherein rod 30 preferably comprises shaft 32, first end 34, second end 36 and collar 38. Preferably, first end 34 of rod 30 is hexagon-shaped and dimensioned to be received and retained within aperture 26 of drill 20 to removably secure rod 30 therewithin. Preferably, second end 36 comprises socket 40, wherein socket 40 is hexagon-shaped and dimensioned to receive and retain jack adapter 50 therewithin and thus removably secure jack adapter 50 to rod 30, as more fully described below.

Collar 38 is preferably a cylindrically-shaped pipe that is preferably slidably engaged around shaft 32 of rod 30. As best shown with reference to FIGS. 1-2B, collar 38 preferably comprises threaded nut 42, wherein threaded nut 42 may be utilized in conjunction with bolt B to removably secure rod 30 to knob K of a selected car jack J, as more fully described below. It is contemplated in an alternative embodiment that collar 38 could comprise other fasteners for connecting rod 30 to knob K of a selected car jack J, such as, for exemplary purposes only, ties, straps, clamps, clasps, pins, and/or magnets.

Preferably, jack adapter 50 acts a fastener for removably connecting rod 30 to knob K of a selected car jack J, wherein jack adapter 50 comprises shaft 52 and coupler 54. Shaft 52 preferably partially comprises a hexagonally-shaped cross section, wherein shaft 52 is preferably dimensioned to be received and retained within socket 40 of rod 30 and, thus removably secure jack adapter 50 to rod 30. Coupler 54 is preferably specifically structurally configured to be coupled or connected to knob K of the selected car jack J, wherein coupler 54 may embody a variety of alternative shapes and sizes depending on the type and style of the selected car jack J utilized with tool 10.

Preferably, the car jack most typically utilized with American manufactured automobiles comprises knob K, wherein knob K includes head member H and L-shaped handle LH. Preferably, head member H comprises channel C, and L-shaped handle LH comprises first segment S1 and second segment S2, wherein first segment S1 is perpendicularly disposed on second segment S2. First segment S1 is preferably disposed within channel C of head member H, thereby preferably linking L-shaped handle LH to head member H.

To accommodate for the size and shape of knob K1, coupler 54 of jack adapter 50 preferably comprises base 56, first receiving member 62 and second receiving member 64. Preferably, base 56 comprises first end 58 and second end 60, wherein first receiving member 62 is affixed to base 56 at first end 58, and wherein second receiving member 64 is affixed to base 56 at second end 60. First receiving member 62 and second receiving member 64 preferably comprise recesses 66, 68, respectively.

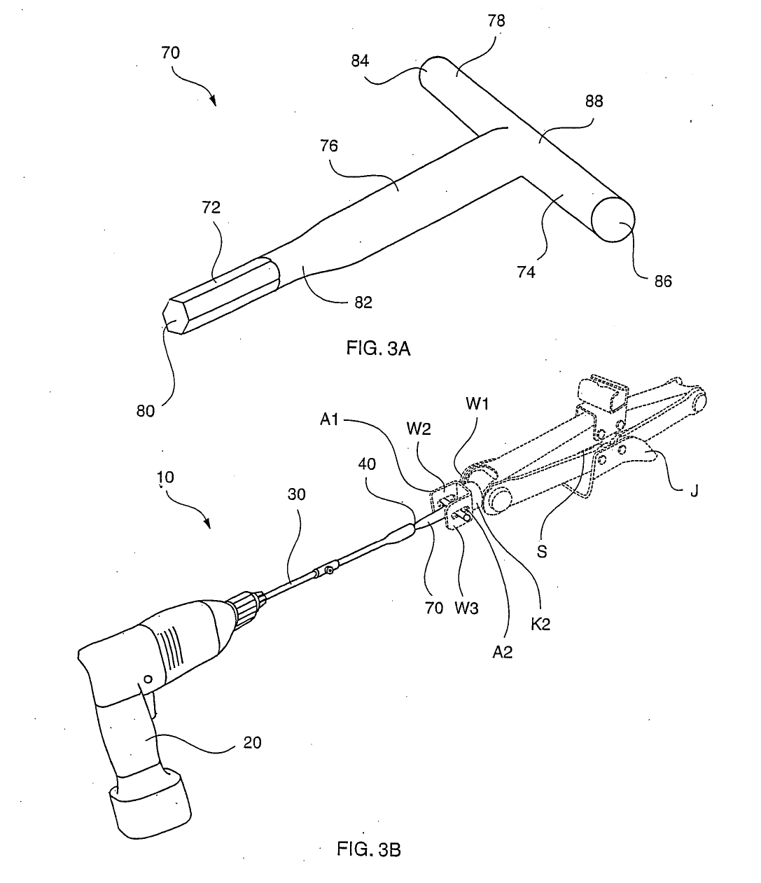

Accordingly, jack adapter 50 may be preferably removably engaged to knob K, wherein first segment S1 of L-shaped handle LH of knob K is preferably received and retained within recesses 66, 68 of jack adapter 50 and preferably held therewithin via frictional engagement. In such a configuration, head member H of knob K1 is preferably positioned between first receiving member 62, second receiving member 64, and base 56 of jack adapter 50. As more fully described below with reference to FIGS. 3A-9B, although jack adapter 50 is preferably utilized in conjunction with knob K of the selected car jack, it is recognized that jack adapter 50 may be replaced with an alternative jack adapter to conform to the type and style of car jack utilized.

To operate tool 10, a selected car jack J is preferably positioned underneath an automobile, wherein car jack J is preferably situated in such a manner that elevation of support member SM would preferably lift the automobile in an upward direction. Preferably, first end 34 of rod 30 is inserted into aperture 26 of drill 20, wherein rod 30 is thereby removably attached to drill 20 via frictional engagement. Preferably, shaft 52 of jack adapter 50 is inserted into socket 40 of rod 30, wherein jack adapter 50 is thereby removably attached to rod 30 via frictional engagement.

Further, coupler 54 of jack adapter 50 is preferably connected to knob K of the selected car jack J. It is contemplated that jack adapter 50 could be attached to car jack J prior to attaching jack adapter 50 to rod 30. As described above, first segment S1 of L-shaped handle LH of knob K is preferably received and retained within cavities 66, 68 of coupler 54 of jack adapter 50.

Referring now back to FIGS. 1-2B, preferably, if knob K comprises elongated crankshaft CS, elongated crankshaft CS is attached to collar 38 of rod 30 via threaded nut 42 and bolt B, wherein bolt B is inserted into orifice O of crankshaft CS and received within threaded nut 42.

To lift the automobile, selector 23 is preferably utilized to select a clockwise rotational direction and trigger 22 is preferably depressed to activate the mechanical drive means of drill 20. Consequently, a clockwise torsional force is preferably created by drill 20, wherein such force is preferably transferred through rod 30, jack adapter 50, and knob K, and subsequently into jack shaft S. Accordingly, vertices V1 and V2 of car jack J are preferably urged towards one another, thereby preferably forcing vehicle support member SM upwards and away from base member BM.

To lower the automobile, selector 23 is preferably utilized to select a counterclockwise rotational direction and trigger 22 is preferably depressed to activate the mechanical drive means of drill 20. Consequently, a counterclockwise torsional force is preferably created by drill 20, wherein such force is preferably transferred through rod 30, jack adapter 50, and knob K, and into jack shaft S. Accordingly, vertices V1 and V2 of car jack J are preferably forced away from one another, thereby preferably urging vehicle support member SM downward and toward base member BM.

Referring now more specifically to FIGS. 3A-3B, in an alternative embodiment, tool assembly 10 comprises jack adapter 70, wherein jack adapter 70 comprises shaft 72 and coupler 74. Shaft 72 partially comprises a hexagonally-shaped cross-section, wherein shaft 72 is dimensioned to be received and retained within socket 40 of rod 30 to thereby removably secure jack adapter 70 to rod 30. Coupler 74 is specifically structurally configured to be coupled or connected to knob K2 of the selected car jack J, wherein coupler 74 comprises first segment 76 and second segment 78, wherein first segment 76 comprises first end 80 and second end 82, and wherein second segment 78 comprises first portion 84, second portion 86 and middle portion 88. First end 80 of first segment 76 is affixed to shaft 72 of jack adapter 70 and second end 82 of first segment 76 is affixed to middle portion 88 of second segment 78, thereby creating a “T”-shaped adapter.

In such an alternative embodiment, jack adapter 70 is adapted to be removably engaged to knob K2, wherein knob. K2 comprises first wall W1, second wall W2, and third wall W3. First wall W1 comprises a first end and a second end, wherein second wall W2 is perpendicularly affixed to the first end of first wall W1, and wherein third wall W3 is perpendicularly affixed to the second end of first wall W1, thereby creating a “U”-shaped knob. Second wall W2 and third wall W3 possess apertures A1, A2, respectively, wherein apertures A1, A2 are adapted to receive and retain first portion 84 and second portion 86, respectively, of second segment 78 of jack adapter 70 therewithin, to thereby removably attach jack adapter 70 to knob K2 of the selected car jack J. Accordingly, as previously described, actuation of drill D in a clockwise or counterclockwise direction can either raise or lower the selected car jack J.

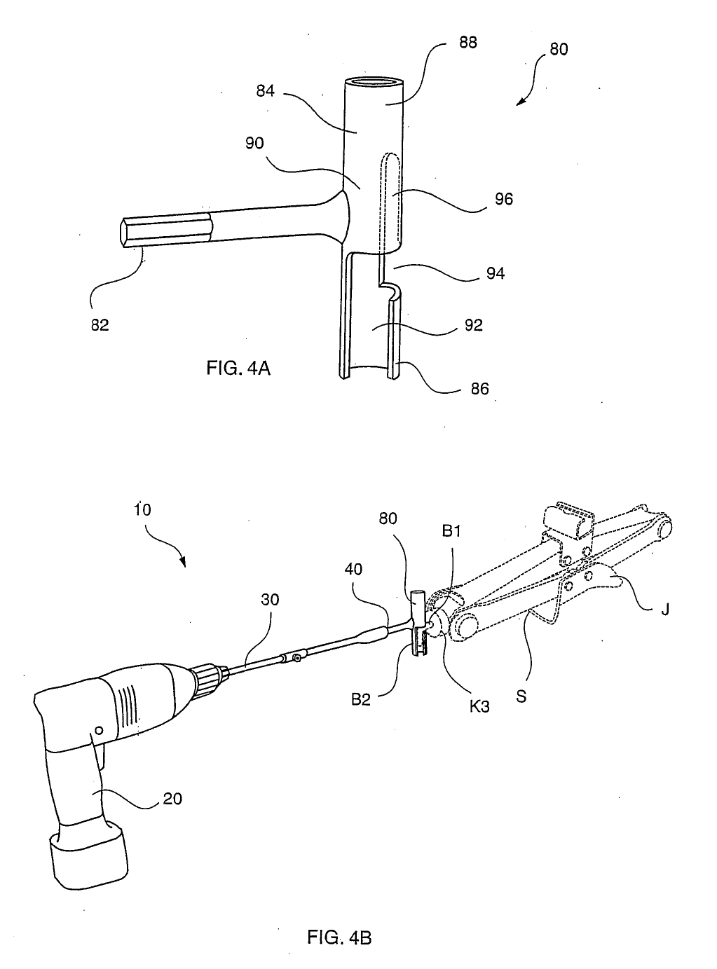

Referring now more specifically to FIGS. 4A-4B, in another alternative embodiment, tool assembly 10 comprises jack adapter 80, wherein jack adapter 80 comprises shaft 82 and coupler 84. Shaft 82 partially comprises a hexagonally-shaped cross-section, wherein shaft 82 is dimensioned to be received and retained within socket 40 of rod 30 to thereby removably secure jack adapter 80 to rod 30. Coupler 84 is specifically structurally configured to be coupled or connected to knob K3 of the selected car jack J, wherein coupler 84 is tubular shaped, and wherein coupler 84 comprises first portion 86, second portion 88, and middle portion 90. Coupler 84 further comprises slots 92, 94 and 96, wherein slot 92 is situated proximate first portion 86, and wherein slot 94 is situated proximate first portion 86 and middle portion 90, and wherein slot 96 is situated proximate middle portion 90 and second portion 88.

In such an alternative embodiment, jack adapter 80 is adapted to be removably engaged to knob K3, wherein knob K3 comprises first bar B1 and second bar B2, wherein second bar B2 is perpendicularly affixed to first bar B1. To attach jack adapter 80 to knob K3, second bar B2 of knob K3 is inserted into slot 92 of jack adapter 80 until second bar B2 of knob K3 comes into contact with slot 94 of jack adapter 80. Next, second bar B2 is urged through slot 94 until second bar B2 comes into contact with slot 96. Finally, second bar B2 is urged through slot 96, thereby removably securing knob K3 within jack adapter 80. Accordingly, as previously described, actuation of drill D in a clockwise or counterclockwise direction can either raise or lower the selected car jack J.

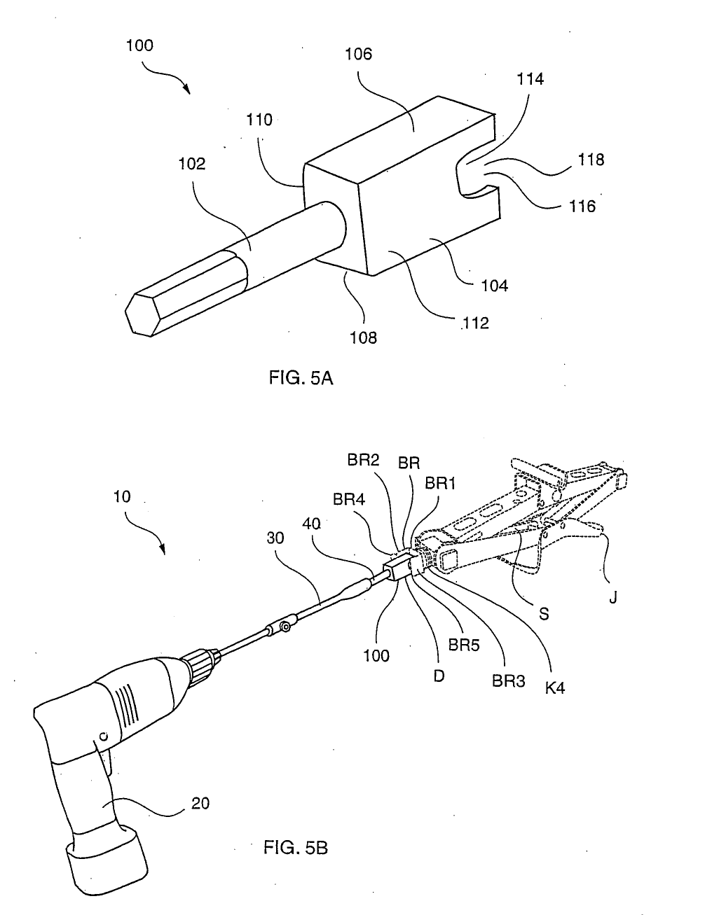

Referring now more specifically to FIGS. 5A-5B, in still another alternative embodiment, tool assembly 10 comprises jack adapter 100, wherein jack adapter 100 comprises shaft 102 and coupler 104. Shaft 102 partially comprises a hexagonally-shaped cross-section, wherein shaft 102 is dimensioned to be received and retained within socket 40 of rod 30 to thereby removably secure jack adapter 100 to rod 30. Coupler 104 is specifically structurally configured to be coupled or connected to knob K4 of the selected car jack J, wherein coupler 104 is substantially cubical shaped, wherein coupler 104 comprises first wall 106, second wall 108, third wall 110 and fourth wall 112, and wherein first wall 106, second wall 108, third wall 110 and fourth wall 112 are affixed together to collectively form coupler 104. First wall 106 is situated proximate second wall 108 at a 90-degree angle therefrom; second wall 108 is situated proximate third wall 110 at a 90-degree angle therefrom; third wall 110 is situated proximate fourth wall 112 at a 90-degree angle therefrom; and fourth wall 112 is situated proximate first wall 106 at a 90-degree angle therefrom. Third wall 110 and fourth wall 112 further comprise slots 114, 116, respectively, wherein slots 114, 116 form notch 118.

In such an alternative embodiment, jack adapter 100 is adapted to be removably engaged to knob K4, wherein knob K4 comprises bracket BR and dowel D. Bracket BR is “U”-shaped, wherein bracket BR comprises first wall BR1, second wall BR2 and third wall BR3, wherein second wall BR2 and third wall BR3 contain apertures BR4, BR5, respectively, and wherein dowel D is disposed within apertures BR4, BR5. It is recognized that bracket BR could embody other shapes and/or sizes, so long as bracket BR links dowel D to threadable jack shaft S of the selected car jack J, and wherein dowel D is substantially perpendicularly oriented relative to threadable jack shaft S. To removably connect jack adapter 100 to knob K4, dowel D of knob K4 is inserted within notch 118 of jack adapter 100 and held therewithin via frictional engagement. Accordingly, as previously described, actuation of drill D in a clockwise or counterclockwise direction can either raise or lower the selected car jack J.

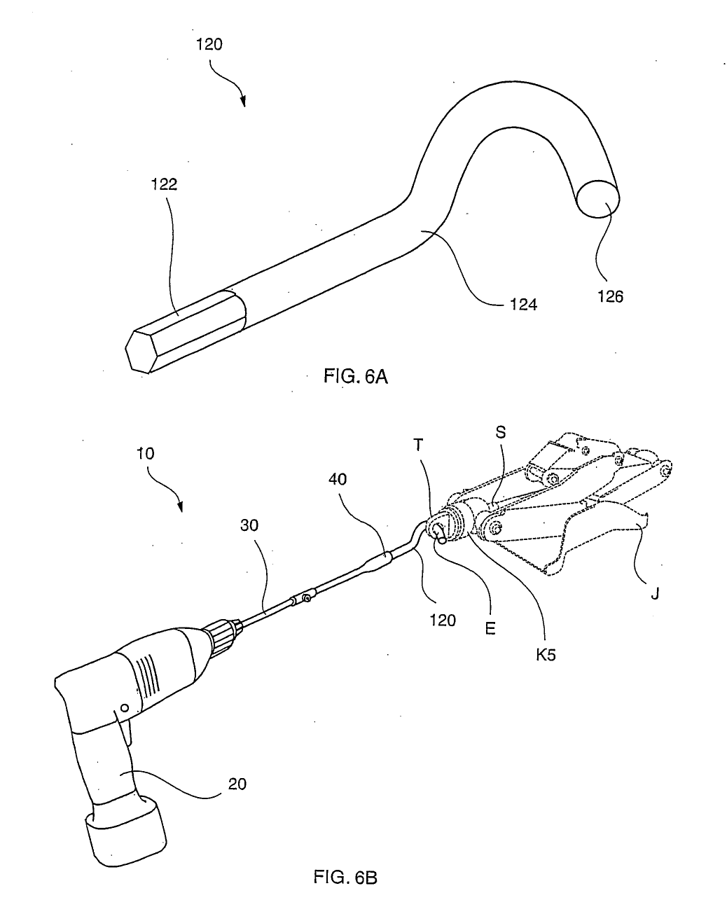

Referring now more specifically to FIGS. 6A-6B, in yet another alternative embodiment, tool assembly 10 comprises jack adapter 120, wherein jack adapter 120 comprises shaft 122 and hook 124. Shaft 122 partially comprises a hexagonally-shaped cross-section, wherein shaft 122 is dimensional to be received and retained within socket 40 of rod 30 to thereby removably secure jack adapter 120 to rod 30. Hook 124 is specifically structurally configured to be coupled or connected to knob K5 of the selected car jack J, wherein hook 124 comprises distal end 126.

In such an alternative embodiment, jack adapter 120 is adapted to be removably engaged to knob K5, wherein knob K5 comprises tab T and eye E. Tab T is linked to threadable jack shaft S of the selected car jack J, wherein tab T is perpendicularly oriented relative to threadable jack shaft S, and wherein eye E is disposed on tab T. To removably connect jack adapter 120 to knob K5, distal end 126 of jack adapter 120 is inserted into eye E of knob K5. Accordingly, as previously described, actuation of drill D in a clockwise or counterclockwise direction can either raise or lower the selected car jack J.

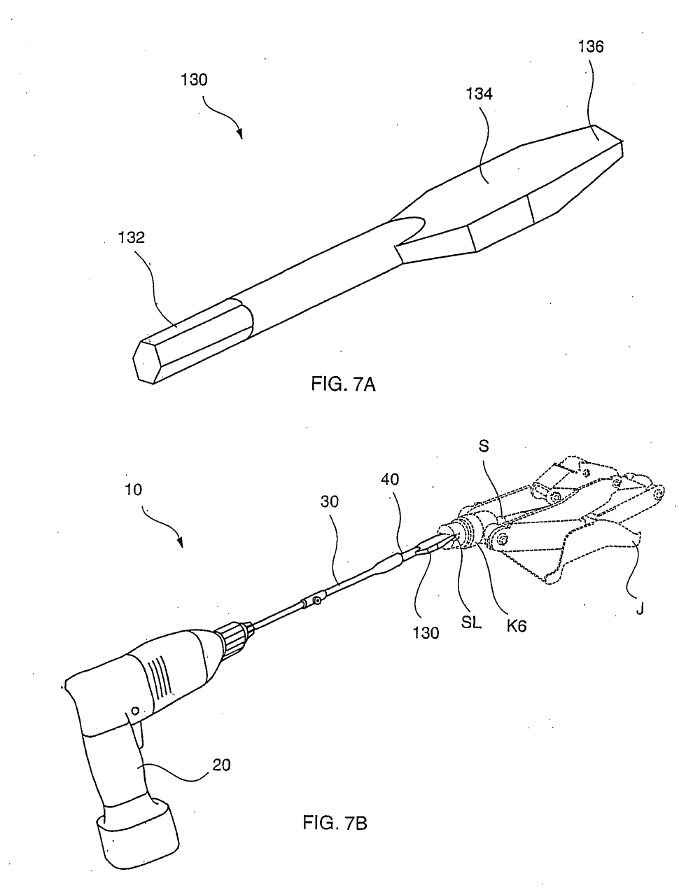

Referring now more specifically to FIGS. 7A-7B, in still yet another alternative embodiment, tool assembly 10 comprises jack adapter 130, wherein jack adapter 130 comprises shaft 132 and coupler 134. Shaft 132 partially compressed hexagonally-shaped cross section, wherein shaft 132 is dimensional to be received and retained within socket 40 of rod 30 to thereby removably secure jack adapter 130 to rod 30. Coupler 134 is specifically structurally configured to be coupled or connected to knob K6 of the selected car jack J, wherein coupler 134 comprises flat head 136.

In such an alternative embodiment, jack adapter 130 is adapted to be removably engaged to knob K6, wherein knob K6 comprises slit SL. To removably connect jack adapter 130 to knob K6, flat head 136 of jack adapter 130 is inserted into slit SL of knob K6 and held therewithin via frictional engagement. Accordingly, as previously described, actuation of drill D in a clockwise or counterclockwise direction can either raise or lower the selected car jack J.

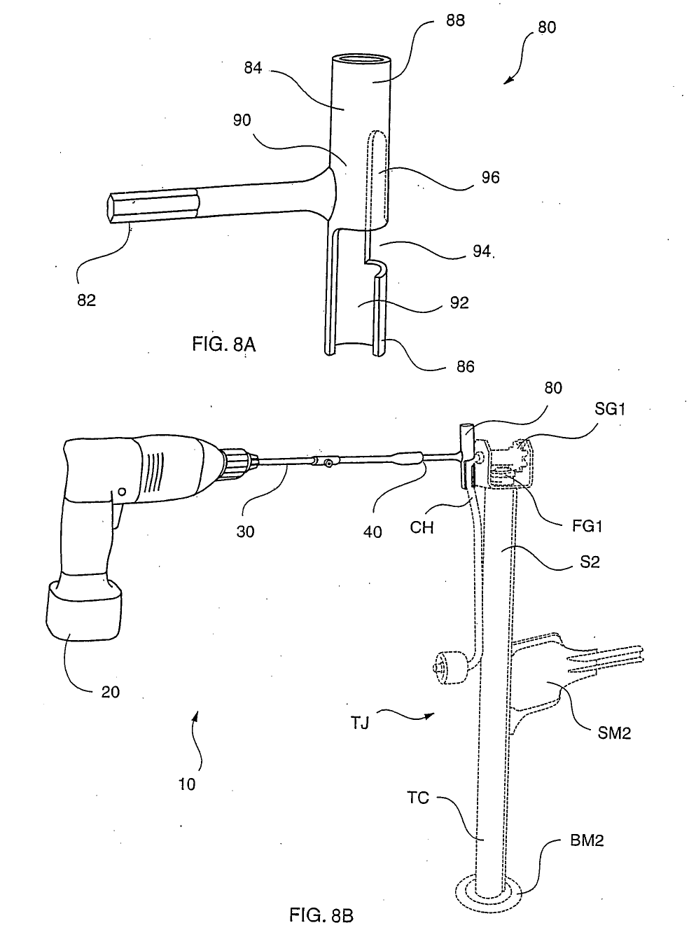

Referring now more specifically to FIGS. 8A-8B, in a further alternative embodiment, tool 10 may also be utilized in conjunction with jack TJ, wherein jack TJ is a conventional tower-type car jack, as is commonly known within the art. Jack TJ generally comprises base member BM2, tower casing TC, threadable jack shaft S2, vehicle support member SM2, crank handle CH, first gear FG and second gear SG.

Briefly described, tower casing TC and threadable jack shaft S2 each comprise a top end and a bottom end, wherein threadable jack shaft S2 is situated within tower casing TC, wherein the top end of threadable jack shaft S2 is positioned proximate to the top end of tower casing TC, and wherein the bottom end of threadable jack shaft S2 is positioned proximate to the bottom end of tower casing TC. Base member BM2 is affixed to the bottom end of tower casing TC and first gear FG is affixed to the top end of threadable jack shaft S2. Second gear FG is perpendicularly disposed proximate to first gear FG, and in toothed engagement thereto, wherein second gear SG is affixed to rotary crank handle CH.

Accordingly, a rotational force that is applied to crank handle CH is subsequently transferred to second gear SG, which in turn, is transferred to first gear FG via the toothed engagement. Further, the rotational force carried by first gear G1 is subsequently transferred to threadable jack shaft S2. Vehicle support member SM2 is threadably engaged to threadable jack shaft S2, wherein rotation of threadable jack shaft S2 in a first direction urges vehicle support member SM2 upward, and wherein rotation of threadable jack shaft S2 in a second direction urges vehicle support member SM2 downward.

As such, jack adapter 80 is utilized to connect rod 30 of tool 10 to crank handle CH, wherein an electrically powered rotational force may be applied to threadable jack shaft S of jack TJ. More specifically, crank handle CH is inserted into slot 92 of jack adapter 80 until crank handle CH comes into contact with slot 94 of jack adapter 80. Next, crank handle CH is urged through slot 94 until crank handle CH comes into contact with slot 96. Finally, crank handle CH is urged through slot 96, thereby removably securing crank handle CH within jack adapter 80. Accordingly, as previously described, actuation of drill D in a clockwise or counterclockwise direction can either raise or lower jack TJ.

Alternatively, if crank handle CH contains a removable shaft portion, wherein crank handle CH comprises a hexagonal protrusion, chuck 24 of drill 20 may be directly linked to the hexagonal protrusion of crank handle CH.

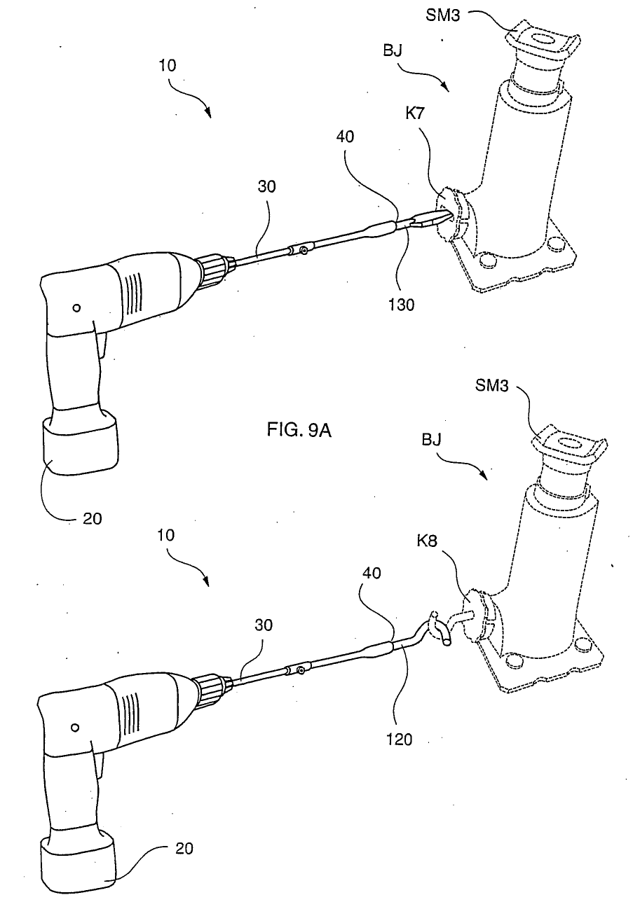

Referring now more specifically to FIGS. 9A, in still a further alternative embodiment, tool 10 may also be utilized in conjunction with jack BJ, wherein jack BJ is a conventional bottle-type car jack, as is commonly known within the art. Jack BJ comprises knob K7 and vehicle support member SM3, wherein rotation of knob K7 raises support member SM3 in an upward direction. Further, knob K7 comprises a rectangular slit centrally disposed thereon, wherein the slit is adapted to receive flat head 136 of jack adapter 130, therewithin. Accordingly, as previously described, actuation of drill D in a clockwise or counterclockwise direction can either raise or lower jack BJ.

In yet a further alternative embodiment, as best shown with reference to FIG. 9B, jack BJ comprises knob K8, wherein knob K8 comprises a hook-shaped protrusion extending outwardly therefrom. Knob K8 is adapted to engage hook 124 of jack adapter 120, wherein knob K8 is coupled to jack adapter 120 via locked engagement. Accordingly, as previously described, actuation of drill D in a clockwise or counterclockwise direction can either raise or lower jack BJ.

In still yet a further alternative embodiment, jack BJ could comprise an alternate form of actuation knob, such as, for exemplary purposes only, a knob comprising apertures, rods, crank handles and/or the like.

In another alternative embodiment, the selected jack adapter could comprise magnetic portions to facilitate linkage to metallic components.

In still another alternative embodiment, rod 30 could be secured to drill 20 via magnets, threaded engagement, locking teeth or a tab-and-slot system.

In yet another alternative embodiment, jack adapter 50 could be secured to rod 30 via magnets, threaded engagement, locking teeth or a tab-and-slot system.

In still yet another alternative embodiment, rod 30 could be telescopic or otherwise extendable.

In a further alternative embodiment, tool 10 could comprise rod extension members, wherein such rod extension members may be removably secured to first end 34 and/or second end 36 of rod 30.

In still further alternative embodiment, tool 10 could lack rod 30, wherein the selected jack adapter is directly coupled to drill 20.

In yet a further alternative embodiment, tool 10 could comprise a light-emitting source for illuminating a work area in dimly-lit settings or at night.

In still yet a further alternative embodiment, drill 20 could be replaced with a suitable motorized rotational device, wherein such device could comprise a power source of any voltage.

In another alternative embodiment, shaft 52 of jack adapter 50 could embody alternate shapes and/or sizes, wherein shaft 52 could comprise, for exemplary purposes only, a circular, semi-circular, triangular or rectangular-shaped cross section.

In still another alternative embodiment, jack adapter 50 could be permanently affixed to rod 30.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A tool for use with a portable car jack comprising:
a powered drive means, wherein said powered drive means creates a rotational force; and
a jack adapter, wherein said jack adapter comprises a hook and connects said tool to the car jack.

2. The tool of claim 1, wherein said powered drive means comprises an electric power drill.

3. The tool of claim 1, wherein said jack adapter is coupled to said powered drive means.

4. The tool of claim 1, further comprising a rod, wherein said rod is coupled to said powered drive means, and wherein said jack adapter is coupled to said rod.

5. The tool of claim 3, wherein said jack adapter is coupled to said powered drive means via an end thereof having a hexagonal cross-section.

6. The tool of claim 4, wherein said jack adapter is coupled to said rod via an end thereof having a hexagonal cross-section.

7. The tool of claim 1, wherein said hook removably engages an eye disposed in a tab of said car jack.

8. The tool of claim 1, wherein said hook removably engages a hook of said car jack.

9. The tool of claim 7, wherein at least one of clockwise rotation of said jack adapter and counterclockwise rotation of said jack adapter causes said car jack to raise or lower.

10. The tool of claim 8, wherein at least one of clockwise rotation of said jack adapter and counterclockwise rotation of said jack adapter causes said car jack to raise or lower.

11. An apparatus for coupling to a knob of a car jack for electrically operating the car jack, wherein said apparatus comprises:
a drive means for engaging the knob of a car; and
a powered means for imparting a rotational force on said drive means to operate the car jack,
wherein said drive means comprises a hook.

12. The apparatus of claim 11, wherein said powered means comprises an electric drill.

13. The apparatus of claim 11, wherein said drive means is coupled to said powered means.

14. The apparatus of claim 11, further comprising an extension means, wherein said extension means is coupled to said powered means, and wherein said drive means is coupled to said extension means.

15. The apparatus of claim 13, wherein said drive means is connected to power means via an end having a hexagonal cross-section.

16. The apparatus of claim 14, wherein said drive means is connected to extension means via an end having a hexagonal cross-section.

17. The apparatus of claim 11, wherein said hook removably engages an aperture formed in a knob of the car jack.

18. The apparatus of claim 11, wherein said hook removably engages a hook of the car jack.

19. The apparatus of claim 17, wherein at least one of clockwise rotation of said drive means and counterclockwise rotation of said drive means causes said car jack to raise or lower.

20. The apparatus of claim 18, wherein at least one of clockwise rotation of said drive means and counterclockwise rotation of said drive means causes said car jack to raise or lower.
